(19) United States
(12) Patent Application Publication
(10) Pub. No.: US 2026/0350130 A1
(43) Pub. Date: Nov. 5, 2026

(54) SYSTEMS AND METHODS FOR MULTI-FACTOR AUTHENTICATION USING MULTIMODAL LARGE LANGUAGE MODEL

(71) Applicant: The Toronto-Dominion Bank, Toronto (CA)

(72) Inventors: Mohsen RAZA, Toronto (CA); Shahriar TAHERI, Newmarket (CA)

(73) Assignee: The Toronto-Dominion Bank, Toronto (CA)

(21) Appl. No.: 19/181,416

(22) Filed: Apr. 17, 2025

(51) Int. Cl. G06F 21/32; G06F 3/04842; G10L 15/22

(52) U.S. Cl. CPC G06F 21/32; G06F 3/04842; G10L 15/22; G06F 2221/2113

(57) ABSTRACT

The present application relates to voice authentication, and more particularly, to systems and methods for voice authentication of an interaction between multiple parties. The system comprises a communications module; a processor coupled to the communications module; and a memory coupled to the processor. The processor-executable instructions configure the processor to: retrieve a voiceprint from a voiceprint database corresponding to the first factor authentication; send, to the computing system, receive a voice data stream; perform a second factor authentication by performing voice authentication of the voice data stream with the voiceprint; analyze the voice data stream to identify a command and at least one parameter that define at least one operation; and send a signal causing the computing system to initiate the at least one operation.

### TECHNICAL FIELD

The present application relates to multi-factor authentication, and more particularly, to systems and methods for authentication comprising voice authentication during interaction of two parties.

### BACKGROUND

Voice authentication is a biometric technology that verifies an identity based on unique vocal characteristics. Voice authentication uses the distinct features of a voice, such as pitch, tone, and speech patterns, to create a voiceprint that can be used for authentication. The process typically involves speaking a specific phrase or sentence, which the system then analyzes and compares to the stored voiceprint.

### BRIEF DESCRIPTION OF THE DRAWINGS

Embodiments are described in detail below, with reference to the following drawings:

FIG. 1 is a schematic operation diagram illustrating an operating environment;

FIG. 2 is a logical block diagram of a teller-computing system;

FIG. 3 is a high-level operation diagram of a resource server;

FIG. 4 is a high-level software architecture executing on a computing device;

FIG. 5 is a high-level schematic diagram on a parallel processing architecture;

FIG. 6 is a block diagram of a training system for the parallel processing architecture;

FIG. 7 is a flowchart showing an enrollment process for an authentication model;

FIG. 8 is a flowchart showing an authentication process using the authentication model;

FIG. 9 is a flowchart showing a combined authentication process and a command identification process;

FIG. 10 is a flowchart showing an example command process;

FIG. 11 is a flowchart showing another example command process; and

FIG. 12 is a flowchart showing the authentication process according to another aspect.

Like reference numerals are used in the drawings to denote like elements and features.

### DETAILED DESCRIPTION

According to an aspect, there is provided a server that may comprise: a communications module; at least one processor coupled to the communications module; and a memory coupled to the at least one processor, the memory storing a plurality of processor-executable instructions. The instructions, when executed, configure the at least one processor to: receive, via the communications module and from a computing system, a voice data signal that includes a continuous voice data stream; perform a second factor authentication at least by performing voice authentication of the continuous voice data stream with a voiceprint from a first factor authentication; analyze the continuous voice data stream to identify a command and at least one parameter associated with the command that define at least one operation; and send, via the communications module and to the computing system, an initiation signal that causes the computing system to initiate the at least one operation. The first factor authentication data may include at least one of an account number and a token. In some aspects, the instructions may configure the at lest one processor to: retrieve the voiceprint from a voiceprint database corresponding to a first factor authentication data.

When performing the voice authentication, the processor-executable instructions, when executed, further configure the at least one processor to: generate a similarity score between the continuous voice data stream and the voiceprint; and determine that the similarity score is above a threshold to complete the voice authentication.

According to an aspect, the instructions may further configure the at least one processor to: engage a large language model at least to analyze the voice data stream to identify the command and the at least one parameter associated with the command. The large language model may generate structured data that includes the command and the at least one parameter and the initiation signal includes the structured data that causes the computing system to initiate the at least one operation. The structured data may be analyzed by the computing system to match the command to at least one predefined operation to select the at least one operation. The computing system may load at least one graphical user interface associated with the at least one operation. The at least one graphical user interface includes at least one data input field and automatically populates the at least one data input field with at least a portion of the structured data. The graphical user interface may include at least one selectable interface element to complete the at least one operation. The instructions, when executed by the at least one processor, may further configure the at least one processor to: receive, via the communications module and from the computing system, a selection signal indicating a selection of the at least one selectable interface element to complete the at least one operation; and perform the at least one operation.

According to an aspect, the initiation signal that causes the computing system to initiate the operation may cause the computing system to display a graphical user interface associated with the operation. The graphical user interface may include at least one data input field and the initiation signal that causes the computing system to initiate the operation populates the at least one data input field based at least on the command and the at least one parameter. The graphical user interface may include at least one selectable interface element to complete the operation. The instructions, when executed by the at least one processor, may further configure the at least one processor to: receive, via the communications module and from the computing system, a selection signal indicating a selection of the at least one selectable interface element to complete the operation; and perform the operation.

According to an aspect, the processor-executable instructions, when executed by the at least one processor, may further configure the at least one processor to: identify at least one missing parameter for the command; and send, via the communications module and to the computing system, a notification signal causing the computing system to display a notification that includes a request for the at least one missing parameter.

According to another aspect, there is provided a computer-implemented method comprising: receiving, via a communications module and from a computing system, a voice data signal that includes a continuous voice data stream; performing a second factor authentication at least by performing voice authentication on the voice data stream with a voiceprint from a first factor authentication; analyzing the voice data stream to identify a command and at least one parameter associated with the command that define at least one operation; and sending, via the communications module and to the computing system, an initiation signal causing the computing system to initiate at least one operation. The first factor authentication data includes at least one of an account number and a token. The method may retrieve a voiceprint from a voiceprint database corresponding to the first factor authentication data.

According to an aspect, when performing the voice authentication, the method may further comprise: generating a similarity score between the voice data stream and the voiceprint; and determining that the similarity score is above a threshold to complete the voice authentication.

According to an aspect, the method may further comprise: engaging a large language model at least to analyze the voice data stream to identify the command and the at least one parameter associated with the command. The large language model may generate structured data that includes the command and the at least one parameter and the initiation signal includes structured data that causes the computing system to initiate the at least one operation. The method may further comprise analyzing, by the computing system, to match the command to at least one predefined operation to select the at least one operation. The method may further comprise loading, by the computing system, at least one graphical user interface associated with the at least one operation; and automatically populating the at least one data input field with at least a portion of the structured data.

According to an aspect, the initiation signal that causes the computing system to initiate the operation may cause the computing system to display a graphical user interface associated with the operation. The graphical user interface may include at least one input field, and the initiation signal that causes the computing system to initiate the operation may populate the at least one input field based at least on the command and the at least one parameter. The graphical user interface may include at least one selectable interface element for completing the at least one operation. The method may further comprise: receiving, via the communications module and from the computing system, a selection signal indicating a selection of the at least one selectable interface element for completing the at least one operation; and performing the at least one operation.

According to yet another aspect, there is provided a non-transitory computer readable storage medium comprising processor-executable instructions. The instructions, when executed, configure at least one processor to: retrieve a voiceprint from a voiceprint database corresponding to the first factor authentication data; receive, via a communications module and from a computing system, a voice data signal that includes a voice data stream; perform second factor authentication at least by performing voice authentication on the voice data stream with the voiceprint; analyze the voice data stream to identify a command and at least one parameter associated with the command that define an operation; and send, via the communications module and to the computing system, an initiation signal causing the computing system to initiate the operation.

Other aspects and features of the present application will be understood by those of ordinary skill in the art from a review of the following description of examples in conjunction with the accompanying figures.

In the present application, the term “and/or” is intended to cover all possible combinations and sub-combinations of the listed elements, including any one of the listed elements alone, any sub-combination, and/or all the elements, and may include additional elements.

In the present application, the phrase “at least one of . . . or . . . ” is intended to cover any one or more of the listed elements, including any one of the listed elements alone, any sub-combination, or all the elements, and may include any additional elements, and may not require all the elements.

In the present application, examples involving a general-purpose computer, aspects of the disclosure transform the general-purpose computer into a special-purpose computing device when configured to execute the instructions described herein.

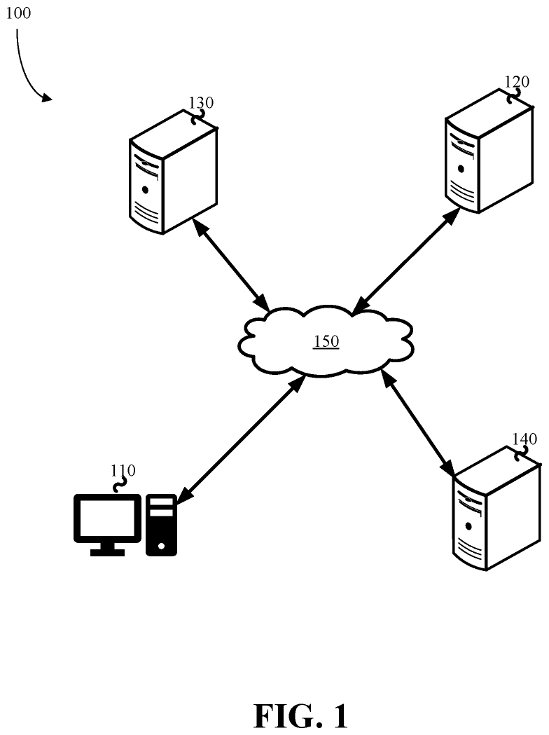

FIG. 1 is a schematic operation diagram illustrating an operating environment. As shown, a networked computing system 100 may include a teller-computing system 110, a central counterparty server 120, a parallel computing server 140, and a resource server 130 coupled to one another through a network 150, which may include a public network such as the Internet and/or a private network. The teller-computing system 110 may be referred to as a computing device and may be associated with one or more tellers working at a branch of a bank or other type of financial provider (e.g. payday loans, credit unions, etc.). The teller-computing system 110, the central counterparty server 120, the parallel computing server 140, and the resource server 130 may be in geographically disparate locations. Put differently, the teller-computing system 110, the central counterparty server 120, the parallel computing server 140, and the resource server 130 may be located remote from one another. In other aspects, the parallel computing server 140 and the resource server 130 may be located at the same location. In some aspects, the resource server 130 and the parallel computing server 140 may be part of a cloud configuration. For instance, the resource server 130 and/or the parallel computing server 140 may be virtualized and may comprise one or more shared resource pools.

The resource server 130 may be referred to as an access control server and may be configured to control access to protected data stored within a plurality of secure-logical storages. The resource server 130 may maintain a protected data resource storing database records for a plurality of entities. In at least some aspects, the resource server 130 may be provided by a financial institution which may maintain customer bank accounts. The protected data resource that may be logically separated into one or more secure-logical storages associated with one or more entities. The secure-logical storages may store a data record that may, for example, reflect an amount of value stored in that secure-logical storage associated with the entity. The resource server 130 may protect the secure-logical storages using bank-grade security. The resource server 130 and/or the central counterparty server 120 may be connected over the network 150 via a virtual private network and/or a bank-grade encryption protocol.

While FIG. 1 illustrates the central counterparty server 120, the parallel computing server 140, and the resource server 130 as single servers, more than one such server may be engaged and connected through the network 150. Further, the resource server 130 may be connected to one or more data resources such as, for example, a computer system that includes one or more database servers, computer servers, and the like. The protected data resource and/or the central counterparty server 120 may provide, for example, an application programming interface (API) for a web-based system, operating system, database system, computer hardware, and/or software library.

The system 100 includes at least one of the application servers executing on the resource server 130. The application server may be associated with an application 410 (such as a web or application) that is resident on the teller-computing system 110. The application 410 may retrieve and/or instruct the application server via an application programming interface (API). For example, the application server may connect the teller-computing system 110 to a back-end system associated with the application 410. The application server may be configured to perform, among others, user management, data storage, security, transaction processing, resource pooling, push notifications, messaging, and/or off-line support of the application 410. The application server may be connected to the teller-computing system 110, the central counterparty server 120, and/or the parallel computing server 140 via the network 150.

The network 150 is a computer network. In some aspects, the network 150 may be an internetwork such as may be formed of one or more interconnected computer networks. For example, the network 150 may be or may include an Ethernet network, an asynchronous transfer mode (ATM) network, a wireless network, a telecommunications network, a satellite network, or the like.

The teller-computing system 110, the central counterparty server 120, the resource server 130, and the parallel computing server 140 are computer systems. The teller-computing system 110 may take a variety of forms including, for example, a mobile communication device such as a smartphone, a tablet computer, a wearable computer such as a head-mounted display or smartwatch, a laptop or desktop computer, or a computing device of another type. In some aspects, the entity may operate the teller-computing system 110 to cause the teller-computing system 110 to perform one or more operations as described herein.

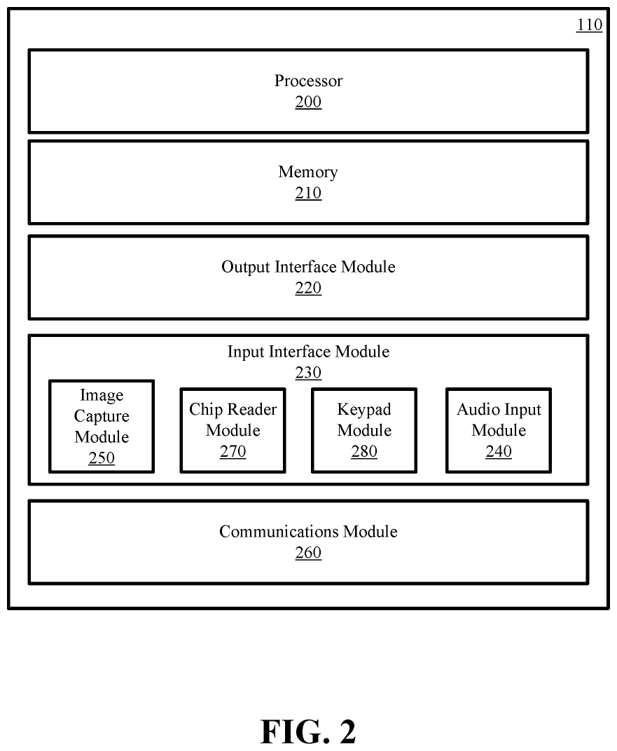

FIG. 2 illustrates components of the teller-computing system 110. The teller-computing system 110 includes a variety of modules. For example, as illustrated, the teller-computing system 110, may include a processor 200, a computer-readable memory 210 (also known as a non-transitory computer readable storage medium), an output interface module 220, an input interface module 230, an audio input module 240, an image capture module 250, a card reader module 270, a keypad module 280, and/or a communications module 260. The foregoing example modules of the teller-computing system 110 may be in communication over a bus.

The processor 200 is a hardware processor. The processor 200 may, for example, be one or more ARM, Intel x86, PowerPC processors or the like.

The computer-readable memory 210 allows data and/or instructions to be stored and retrieved. The computer-readable memory 210 may include, for example, random access memory, read-only memory, and persistent storage. Persistent storage may include, for example, flash memory, a solid-state drive or the like. Read-only memory and persistent storage are a computer-readable medium. A computer-readable medium may be organized using a file system such as may be administered by an operating system 420 governing overall operation of the teller-computing system 110. The computer-readable memory 210 may comprise a storage module for storing and retrieving data. Additionally or alternatively, the storage module may be used to store and retrieve data from persisted storage that may not be accessible via the computer-readable memory 210. In some aspects, the storage module may be used to store and retrieve data in a database. A database may be stored in persisted storage. Additionally or alternatively, the storage module may access data stored remotely such as, for example, as may be accessed using a local area network (LAN), wide area network (WAN), personal area network (PAN), and/or a storage area network (SAN). In some aspects, the storage module may access data stored remotely using the communications module 260. In some aspects, the storage module may be omitted, and its function may be performed by the computer-readable memory 210 and/or by the processor 200 in concert with the communications module 260 such as, for example, when data is stored remotely. The storage module may also be referred to as a data store.

The input interface module 230 allows the teller-computing system 110 to receive input signals. Input signals may, for example, correspond to input received from a teller. The input interface module 230 may serve to interconnect the teller-computing system 110 with one or more input devices. Input signals may be received from input devices by the input interface module 230. Input devices may, for example, include one or more of a touchscreen input, keyboard, trackball, voice command interface, or the like. In some aspects, all or a portion of the input interface module 230 may be integrated with an input device. For example, the input interface module 230 may be integrated with one of the input devices. The input interface module 230 may include an input device allowing input to be provided to the teller-computing system 110. Input received via the input interface module 230 may be conveyed to the processor 200. A card reader module 270 and a keypad module 280 may be used by the entity to provide a chip and personal identification number (PIN) authentication to the teller-computing system 110 as a part of an authentication application executing on the teller-computing system 110 with an authentication server executing on the resource server 130 as described in further detail herein.

The card reader module 270 reads card data from a card or access card, such as, for example, a common ISO-sized automated teller machine or cheque card. The card may be an EMV card (i.e. Europay, MasterCard, and Visa card) provided by EMVCo, a consortium of major payment companies. For example, the card reader module 270 may read data from a magnetic stripe and/or a chip. In some aspects, the card reader module 270 may read the card by swiping the card through a magnetic reader (a so-called “swipe reader”) and/or the card reader module 270 may read the card by inserting the card into a chip reader (a so-called “dip reader”, i.e. a document insertion processor). In some aspects, the card reader module 270 may be adapted to allow inserted cards to be retained by the teller-computing system 110 indefinitely (such as when a fraudulent transaction is detected) and/or for the period of a session.

The card reader module 270 may work in conjunction with the keypad module 280 to perform a first factor authentication. The first factor authentication may comprise one or more card authentication methods, such as online card authentication and/or offline card authentication, and cardholder verification methods, such as an offline PIN, an online PIN, and/or signature verification. The card authentication may protect the card reader module 270 from counterfeit cards. Online card authentication may involve a transaction to be sent to the resource server 130 to authenticate and authorize using a cryptogram. The cryptogram may be validated by the resource server 130.

Offline card authentication may involve authentication of the card using static data authentication (SDA), dynamic data authentication (DDA), and/or combined DDA with application cryptogram generation. The SDA calculates a cryptogram using a static public key certificate and one or more static data elements. To authenticate the card, the card reader module 270 may load the public root key and may use the public root key to validate a public key certificate. The card reader module 270 may extract the public key from the validated certificate and use the extracted public key to validate the static card data, which has been previously signed by the card issuer.

DDA calculates a cryptogram for each transaction that is unique to the card and the transaction. In addition to the issuer key pair, an asymmetric (RSA) key pair is generated for each card. To authenticate the card, the card reader module 270 follows a similar process as for SDA, except a random number may be sent to the card to be signed by the card private key. The card reader module 270 validates the signature from the card using the public key of the card. Combined DDA with application cryptogram combines DDA with an additional application cryptogram at the end of the transaction to ensure the transaction data maintains integrity against subsequent manipulation.

The cardholder authentication methods may be used to protect the cardholder against use of a lost or stolen card and/or to verify an identity of the entity currently using the card. In some aspects, the online PIN and the offline PIN may be synchronized such that they are the same PIN.

For online PIN verification, the card reader module 270 may read the magnetic stripe and may prompt the entity for their associated online personal identification number (PIN). The entity may enter the online PIN into keypad module 280. The teller-computing system 110 may encrypt the entered PIN using a secure encryption protocol, such as Triple Data Encryption Standard (TDES) before transmitting the online PIN along with the card data (i.e. first factor authentication data) to the resource server 130. The resource server 130 may validate the online PIN against data stored in a database. If the online PIN is confirmed to match the card's associated account, the resource server 130 may send at least one notification signal notifying the teller-computing system 110 that the authentication was successful.

Offline PIN verification uses an offline PIN stored securely on the card. In some aspects, the offline PIN may be synchronized with the online PIN. When the cardholder enters the offline PIN, the card reader module 270 provides the offline PIN to the chip within the card for verification. The chip compares the entered PIN to the stored PIN and sends the result of the comparison back to the card reader module 270. In some aspects, the card reader module 270 may approve the transaction offline (i.e. without transmitting to the resource server 130). In other aspects, the card reader module 270, via the teller-computing system 110, may send the result of the comparison to the resource server 130 for authorization. In this manner, the offline PIN may never be transmitted to the resource server 130 and only the result of the comparison may be transmitted to the resource server 130.

Described another way, the card reader module 270 may read the chip and ensure that the entered PIN matches the offline PIN stored on the chip. In some aspects, the chip of the card may comprise a computer-readable storage and store encrypted data, such as cardholder data (e.g. cardholder's name and account number), card authentication data (e.g. unique transaction codes), PIN verification data, transaction counters, and/or issuer data (e.g. issuer identification number). The chip may generate a unique transaction code to provide to the card reader module 270.

The teller-computing system 110 may transmit the unique transaction code to the resource server 130 for verification. The unique transaction code may be generated by a dynamic data authentication process (DDA) as previously described. The chip stores a set of cryptographic keys saved to the card by the card issuer. The cryptographic keys may be unique to each card. When a transaction is initiated, the teller-computing system 110 provides transaction-specific data (e.g. transaction amount, date, and a unique transaction identifier) to the chip. The chip may use a cryptographic algorithm, such as RSA or Triple DES, to encrypt the transaction data. The result of the encryption is a unique cryptographic code (e.g. a cryptogram). The cryptogram is sent to the resource server 130 along with the transaction data. The resource server 130 may decrypt the cryptogram and verify the transaction data is legitimate.

In some aspects, the input interface module 230 may comprise one or more image capture modules 250 and/or one or more sensor modules. The image capture module 250 may be or may include a camera. The image capture module 250 may be used to obtain image data, such as images. The image capture module 250 may be or may include a digital image sensor system as, for example, a charge coupled device (CCD) or a complementary metal-oxide-semiconductor (CMOS) image sensor. The sensor module may include a sensor that generates sensor data based on a sensed condition. By way of example, the sensor module may be or include a location subsystem which generates location data indicating a location of the teller-computing system 110. The location may be the current geographic location of the teller-computing system 110. The location subsystem may be or include any one or more of a global positioning system (GPS), an inertial navigation system (INS), a wireless (e.g., cellular) triangulation system, a beacon-based location system (such as a Bluetooth low energy beacon system), or a location subsystem of another type.

In one or more aspects, the image capture module 250 may be adapted to scan or capture image data of one or more value instruments. For example, the image capture module 250 may scan and/or capture image data of value instruments (such as, for example, bank notes, negotiable instruments like cheques, money orders, bank drafts, warrants of payment, redemption codes, titles, deeds, etc.). In some aspects, the value instruments may be represented by one or more quick response (QR) codes. The image capture module 250 may be configured to capture image data in colour, black and white, grayscale, and/or any multispectral light. In one or more aspects, image capture module 250 may include an ultraviolet image sensor and/or an infrared image sensor to capture image data of one or more security features for counterfeit detection. The teller-computing system 110 may send the image data of the value instrument to the resource server 130. The resource server 130 may process the image data as described in further detail below.

In one or more aspects, the input interface module 230 may comprise an audio input module 240 for recording voice data. Voice data may include voice signals and potentially background noise. It may be appreciated that the voice data may be preprocessed to reduce and/or eliminate noise and/or increase the voice signals. The preprocessing may be performed at least partially by the teller-computing system 110. The audio input module 240 may comprise one or more microphones. The techniques described herein are not limited to the type of microphone technology and may be applicable to dynamic microphones, condenser microphones, ribbon microphones, carbon microphones, and/or crystal microphones. The microphones may include omnidirectional, cardioid, figure-8, and/or multi-pattern.

The audio input module 240 may be sensitive between 30-Hz to 20-kHz. In some aspects, the audio input module 240 may be particularly sensitive for human voice, such as in the range of 85-Hz to 255-Hz, or in a broader range of 80-Hz to 1100-Hz. The audio input module 240 may comprise one or more filters to filter an audio signal to these frequency ranges. The filters may include physical filters and/or digital filters. The filters may include high-pass filters to remove low-frequency noise, low-pass filters to remove high-frequency noise, notch filters to remove unwanted sounds, band-pass filters to isolate human voice, noise gate filters to remove audio below a threshold, de-Esser filters to remove harsh “s” sounds, and/or equalizer filters to enhance specific frequency ranges to improve speech intelligibility. In some aspects, multiple microphones may be used to reduce and/or eliminate background noise within the voice data by subtracting the background noise from the voice data. In some aspects, the filters may process the voice data to isolate human voices.

The output interface module 220 allows the teller-computing system 110 to provide output signals. Some output signals may, for example, allow provision of output to a user. The output interface module 220 may serve to interconnect the teller-computing system 110 with one or more output devices. Output signals may be sent to output devices by an output interface module 220. Output devices may include, for example, a display screen such as, for example, a liquid crystal display (LCD), a touchscreen display. Additionally, or alternatively, output devices may include other output devices such as, for example, a speaker, indicator lamps (such as for example light-emitting diodes (LEDs)), and printers. In some aspects, all or a portion of the output interface module 220 may be integrated with an output device. For example, the output interface module 220 may be integrated with one of the output devices.

The communications module 260 allows the teller-computing system 110 to communicate with other electronic devices and/or various communications networks. For example, the communications module 260 may allow the teller-computing system 110 to send or receive communications signals. Communications signals may be sent and/or received according to one or more protocols or according to one or more standards. For example, the communications module 260 may allow the teller-computing system 110 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. The communications module 260 may allow the teller-computing system 110 to communicate using near-field communication (NFC), via Wi-Fi™, using Bluetooth™, via TCP/IP, or via some combination of one or more networks or protocols. In some aspects, all or a portion of the communications module 260 may be integrated into a component of the teller-computing system 110. For example, the communications module 260 may be integrated into a communications chipset.

Software comprising a plurality of instructions is executed by the processor 200 from a computer-readable medium. For example, software may be loaded into random-access memory from persistent storage of computer-readable memory 210. Additionally, or alternatively, instructions may be executed by the processor 200 directly from read-only memory of computer-readable memory 210.

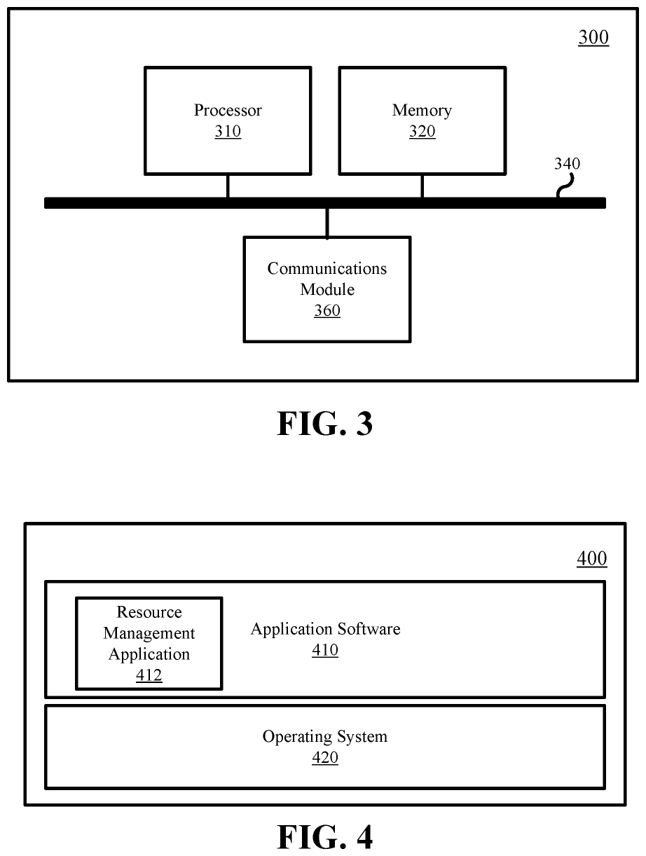

Turning to FIG. 3, the central counterparty server 120 and the resource server 130 are computer server systems 300. A computer server system may, for example, be a mainframe computer, a minicomputer, or the like. In some implementations thereof, a computer server system may be formed of or may include one or more computing devices. A computer server system may include and/or may communicate with multiple computing devices such as, for example, database servers, computer servers, and the like. Multiple computing devices such as these may be in communication using a computer network and may communicate to act in cooperation as a computer server system. For example, such computing devices may communicate using a local-area network (LAN). In some embodiments, a computer server system may include multiple computing devices organized in a tiered arrangement. For example, a computer server system may include middle tier and back-end computing devices. In some aspects, a computer server system may include a cluster formed of a plurality of interoperating computing devices.

The computer server system 300 may comprise a variety of modules. For example, as illustrated, the computer server system 300 may include a processor 310, a computer-readable memory 320, and a communications module 360. These modules may communicate over a bus 340.

The processor 310 may include a hardware processor. The processor 310 may, for example, be one or more ARM, Intel x86, PowerPC processors or the like. The processor 310 may include a single-core or a multi-core processor. The processor 310 may have one or more interfaces, such as buses, ports, etc., for communicating with other hardware devices that are not illustrated to simplify the figure.

The computer-readable memory 320 allows data and/or instructions to be stored and retrieved. The computer-readable memory 320 may include, for example, random access memory, read-only memory, and persistent storage. Persistent storage may include, for example, flash memory, a solid-state drive or the like. Read-only memory and persistent storage are non-transitory computer-readable storage mediums. A computer-readable medium may be organized using a file system such as may be administered by an operating system 420 governing overall operation of the computer server system 300.

The communications module 360 allows the computer server system 300 to communicate over the network 150 to send and receive data via one or more network protocols.

FIG. 4 depicts a simplified organization of software components 400 stored in the computer-readable memory 320 of the computer server system 300 or the computer-readable memory 210 of the teller-computing system 110. As illustrated these software components include an operating system 420 and an application 410. The operating system 420 is software. The operating system 420 allows the application 410 to access the processor 310, the computer-readable memory 320, and/or the communications module 360. The operating system 420 may include, for example, Apple's iOS™, Google's Android™, Linux™, Unix™, Microsoft's Windows™, Apple OSX™, or the like.

The application 410 adapts the computer server system 300 or the teller-computing system 110, in combination with the operating system 420, to operate as a device performing functions as described herein. For example, the application 410 may cooperate with the operating system 420 to adapt a suitable aspect of the computer server system 300 to operate as the resource server 130, and/or the central counterparty server 120. In some aspects, the application 410 may provide an application server for interfacing with an application 410 that is executing on the teller-computing system 110. In another example, the application 410 may cooperate with the operating system 420 to adapt a suitable aspect of the teller-computing system 110 to operate as the resource management application 412. The resource management application 412 may receive data and/or provide commands to the resource management server executing on the resource server 130.

While an application 410 is illustrated in FIG. 3 as a single application, in operation, the computer-readable memory 210 and/or the computer-readable memory 320 may include more than one application 410, and the applications 410 may perform different operations. For example, in aspects where the application 410 is functioning as the resource management application on the teller-computing system 110, the application 410 may be configured for secure communications with the resource server 130 and/or the central counterparty server 120 and may provide various banking functions such as, for example, display of account balances, transfers of value (e.g. bill payments, money transfers), and other resource management functions.

The application data may include one or more of a list of applications installed on the teller-computing system 110, levels of permission granted to the installed applications, internet search history data, and/or activity data indicating activity performed on the teller-computing system 110.

By way of further example, in at least some aspects in which the application 410 executes on the teller-computing system 110, the applications 410 may include a web browser, which may also be referred to as an Internet browser. In at least some such embodiments, the resource server 130 may execute an application server providing a web server that may serve one or more of the interfaces described herein. The web server may cooperate with the web browser and may serve an interface when the interface is requested through the web browser. For example, the web server may serve as a banking interface.

The resource server 130 may be associated with a financial institution and the financial institution may be the same financial institution associated with the teller-computing system 110. The resource server 130 and the teller-computing system 110 may perform operations to provide services to the financial institution. The resource server 130 may perform operations related to performing transactions using the teller-computing system 110. For example, the resource server 130 may perform operations related to authorizing and/or completing transactions based on cheques deposited by the teller-computing system 110. The resource server 130 may additionally or alternatively perform operations related to authenticating an entity of the teller-computing system 110. For example, the resource server 130 may perform operations to authenticate an entity based on data from a card and based on a personal identification number (PIN) received as input by the teller-computing system 110. The services may include receiving image data of value instruments captured by the teller-computing system 110.

The resource server 130 may operate in conjunction with a protected data resource that stores secure data. In particular, the protected data resource may include one or more secure-logical storage locations that may store records for accounts that are associated with various entities. That is, the secure data may comprise account data for one or more specific entities. For example, an entity provides their card to the teller-computing system 110 and once authenticated, the teller-computing system 110 may retrieve an account associated with the card. The account may comprise one or more records in the protected data resource. In at least some aspects, the records may reflect a quantity of stored resources that are associated with the entity. Such resources may include owned resources and/or borrowed resources (e.g. resources available on credit). The quantity of resources that are available to or associated with a secure-logical storage holder may be reflected by a balance defined in an associated record.

For example, the secure data in the protected data resource may include financial data, such as banking data (e.g. bank balance, historical transactions data, etc.) and investment data (e.g. portfolio information) for the entity. In particular, the resource server 130 may include a financial institution (e.g. bank) server and the secure-logical storage holder may be linked to a record of an account of the financial institution which operates the financial institution server. The financial data may, in some aspects, include processed or computed data such as, for example, an average balance associated with an account, an average spending amount associated with an account, a total spending amount over a period, or other data obtained by a processing server based on account data for the entity.

In some aspects, the protected data resource may include a computer system that includes one or more database servers, computer servers, and the like. In some embodiments, the protected data resource may comprise an application programming interface (API) for a web-based system, operating system, database system, computer hardware, or software library.

The central counterparty server 120 may be adapted to be an electronic clearinghouse for resource server 130 to resource server 130 transactions, such as clearing one or more value instruments. In some aspects, the teller-computing system 110 may transmit one or more transactions directly to the central counterparty server 120. In some aspects, the teller-computing system 110 may transmit the transactions to the resource server 130, which may subsequently transmit the transactions to the central counterparty server 120. In some aspects, the resource server 130 may process the transactions and transmit one or more results of the processing to the central counterparty server 120.

In general, the resource server 130 receives the transaction and processes the transaction data to determine an amount of resource to be deposited to a first secure digital storage associated with the entity's card. The resource server 130 may transfer the amount of resource into the first secure digital storage. The resource server 130 may provide the transaction to the central counterparty server 120. The central counterparty server 120 may identify a second resource server (not shown) associated with the transaction. The central counterparty server 120 may route the transaction to the second resource server. The second resource server may determine a second secure digital storage associated with the transaction. The second resource server may transfer the amount of the resource out of the second secure digital storage.

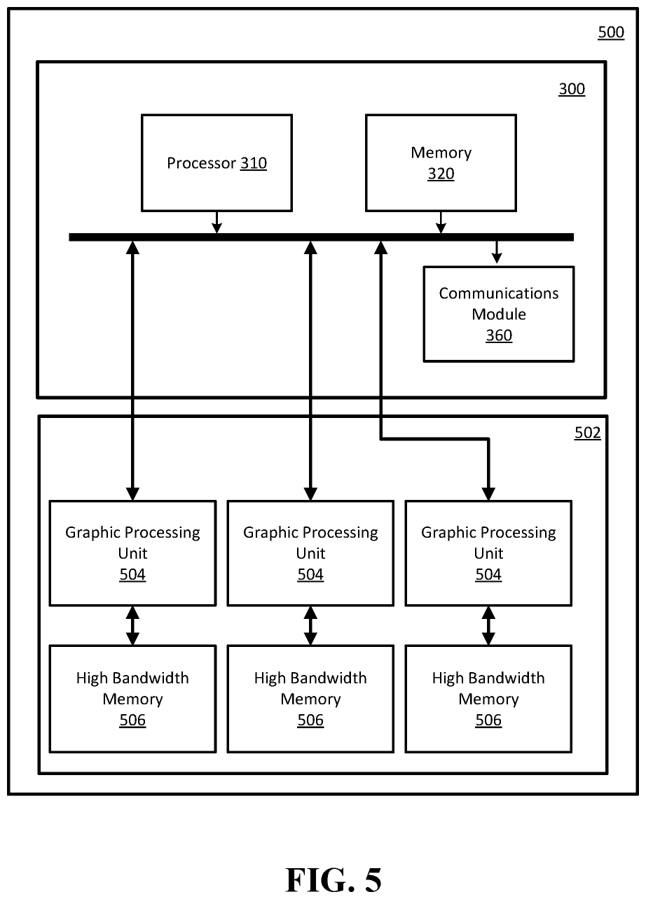

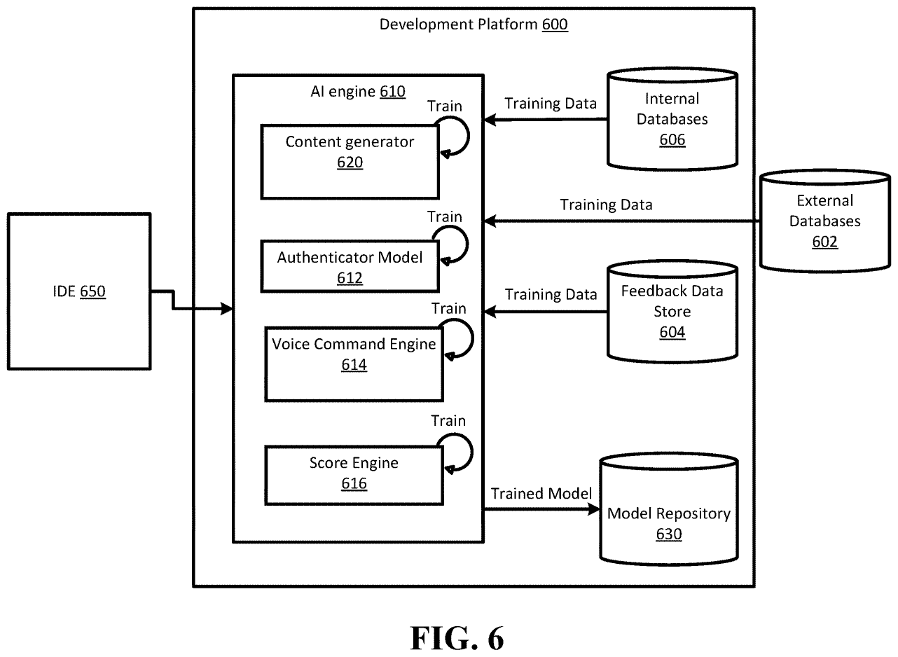

Turning to FIGS. 5 and 6, the parallel computing server 140 comprises a processing structure 500. The processing structure 500 may comprise a computer server system 300 as previously described with reference to FIG. 3. In some aspects, the computer server system 300 may be the same as the resource server 130 in that the computer server system 300 comprises the processor 310, the computer-readable memory 320, and the communications module 360. In other aspects, the computer server system 300 may be a distinct computing server. In any event, the computer server system 300 may manage a parallel computing structure 502. The parallel computing structure 502 may comprise a plurality of graphic processing units (i.e. GPUs 504) having a high-bandwidth memory 506 associated with each of the GPUs 504.

The processor 310 may execute one or more instructions from the computer-readable memory 320 to manage a parallel computing structure 502. The processor 310 may execute a distributing module that may comprise instructions to send, transmit, and/or distribute data to be processed to at least one of the GPUs 504. The distributing module may monitor a workload of the GPUs 504 to select the GPU 504 with available capacity. For example, the GPUs 504 may periodically post workloads to the distributing module (e.g. approximately 15-minute intervals) via an application interface. The distributing module may determine that one of the GPUs 504 has a low workload, or workload below a threshold, and in response, distribute data to be processed to that one of the GPUs 504. In some aspects, the distributing module may cooperate with a priority module to assign to the GPUs 504 a higher or greater priority before lower or lesser priority data transfers.

The parallel computing structure 502 may execute an artificial intelligence engine (i.e. AI engine 610) or more artificial intelligence (AI) engines. In this aspect, the AI engine 610 may comprise one or more replicas of an AI model, such as, but not limited to, a large language model (LLM), a multimodal LLM, a Generative Adversarial Networks (GANs), a Variational Autoencoder (VAE), a Recurrent Neural Network (RNN), a Transformer, a Diffusion Model, and/or any combination thereof executing in series, parallel, and/or recursively. For ease of reference, the replica is generally referred to as the AI engine 610. Each of the replicas may execute on one or more of the GPUs 504. One or more of these AI models may be selected based on the data and/or processing task to be performed as described in further detail herein. The processor 310 may instruct the parallel computing structure 502 to retrieve the selected AI model from a model repository 630 and load the AI model into the high-bandwidth memory 506 for execution by the GPU 504 prior to processing the data. In some aspects, a previously executing AI engine 610 that is no longer being used may be reset in preparation for the new session.

Turning to FIG. 6, an AI development platform 600 is shown for training one or more of the AI models (e.g. 612, 614, 616, 620) of the AI engine 610. An integrated development environment (i.e. IDE 650) may enable a provider to develop, train, and/or retrain the AI engine 610. The IDE 650 may include an application 410 with a programming interface accessible by a developer device (not shown) over the network 150 or via a local connection. The IDE 650 may include a web application that can be accessed at a network address, uniform resource locator (URL), etc. The IDE 650 may be locally or remotely installed on the developer device where the IDE 650 is accessed and used locally.

The IDE 650 may be used to design an AI engine 610 using the user interface of the IDE 650. For example, the user interface may be output as part of the software application that interacts with the IDE 650. A developer may use an input mechanism to make selections from menus to add pieces to the AI engine 610, such as data components, model components, analysis components, etc., within a workspace of the user interface. The menus may include a plurality of graphical user interface (GUI) menu options, which can be selected to reveal additional components that can be added to the model design shown in the workspace. The GUI menu options may include options for adding features such as neural networks, machine learning models, AI models, data sources, conversion processes (e.g., vectorization, encoding, etc.), analytics, etc. The developer may continue to add features to the AI engine 610 and connect the features using edges and/or other means to create a flow within the workspace. For example, the developer may add a node to a flow of a new model within the workspace. For example, the developer may connect a node to another node in the flow via an edge, creating a dependency within the flow. When the developer is done, the IDE 650 can save the AI engine 610 and/or AI models for subsequent training and/or testing.

The training process for training and/or retraining the AI engine 610 may involve an executable script configured to read data from the data resource 606 and/or the external database 602 and input the data to the AI engine 610. For example, the executable script may use identifiers (IDs) of one or more data locations (e.g., table IDs, row IDs, column IDs, topic IDs, object IDs, etc.) to identify locations of the training data within the data resource 606 and query an API of the data resource 606. In response, the data resource 606 may receive the query, load the requested data, and return the data to the executable script, where the data is input to the AI engine 610. The training process may be managed via an interface of the IDE 650, allowing for supervised learning during the training process. In other aspects, the training process may perform unsupervised learning.

In some aspects, the script may iteratively retrieve additional training data sets from the data resource 606 and iteratively input the additional training data sets into the content generator 620 during the execution to continue to train the AI engine 610. The script may continue until instructions within the script direct the script to terminate, which may be based on iterations (e.g. training loops), total time elapsed during the training process, etc.

The IDE 650 may also be used to retrain the AI engine 610 after being deployed. The training process may use executional results that have been generated or output by the content generator 620, the authenticator model 612, and/or the voice command engine 614 in a live environment for retraining. For example, a score engine 616 may score output from the content generator 620, the authenticator model 612, and/or the voice command engine 614 and feedback those scores to retrain the content generator 620, the authenticator model 612, and/or the voice command engine 614 to further enhance accuracy and/or relevancy. The feedback may include indications of whether the generated output scores match or exceed scores resulting from a manual evaluation, such as based on the feedback received from the entity. In yet another example, the feedback from the entity may be used to train and/or retrain the content generator 620, the authenticator model 612, and/or the voice command engine 614 to further enhance its accuracy, relevancy, and/or reliability. The feedback data may be captured and stored within a feedback data store 604 or other data store within the live environment and can be subsequently used to retrain the score engine 616 and/or the content generator 620, the authenticator model 612, and/or the voice command engine 614.

The AI engine 610 may comprise a content generator 620, an authentication model 612, a voice command engine 614, and/or a score engine 616.

The content generator 620 may include a multimodal large language model (LLM) trained to provide one or more artificially generated audio responses to the entity and/or teller. To generate the artificially generated audio response, the content generator 620 may be trained on historical conversation content. The content generator 620 may be trained from historical conversation content from an external database 602 and/or data resource 606. In some aspects, the content generator 620 may be configured to retrieve profile data from a secure-logical storage area associated with the entity. In some aspects, the historical conversation content may include historical conversations with the entity. The profile data may include account information such as financial account information, health information, transaction history, etc.

In some aspects, the content generator 620 may directly receive audio queries over the network 150 from the entity and/or teller using the audio input module 240 of the teller-computing system 110. In response to the audio queries, the content generator 620 may generate an audio response. In this aspect the content generator 620 may comprise an audio-LLM.

In other aspects, the content generator 620 may operate in conjunction with a speech-to-text engine (such as an automatic speech recognition (ASR) and/or natural language processing (NLP)) that transforms the audio queries into textual queries and the content generator 620 may directly generate an audio response. In yet other aspects, the content generator 620 may operate in conjunction with the speech-to-text engine that transforms the audio queries into textual queries and the content generator 620 may generate a textual response. The content generator 620 may operate in conjunction with a text-to-speech engine to transform the textual response into an audio response. The speech-to-text engine may process the audio queries by filtering the audio signal, performing feature extraction, performing acoustic modelling, performing language modelling, and/or decoding. In some aspects, a translation engine may perform translation from one language into another language and vice versa.

In any event, the audio response may be transmitted from the AI engine 610 over the network 150 to the teller-computing system 110. The teller-computing system 110 may play the audio response via the output interface module 220, such as a speaker and/or headphones. In some aspects, the textual response may be transmitted from the AI engine 610 over the network 150 to the teller-computing system 110 and the teller-computing system 110 may perform the text-to-speech conversion to convert the textual response into the audio response.

The authentication model 612 may comprise one or more audio pre-processors, one or more feature extraction processes, one or more training processes, and one or more AI models. The AI models may include one or more of: a Gaussian mixture model (GMM), a hidden Markov model (HMM), a convolutional neural network (CNN), a recurrent neural network (RNN), a deep neural network (DNN), a support vector machine (SVM), a transformer, and/or an autoencoder. GMMs are probabilistic models that represent the distribution of features in voice samples and may be effective in modeling a variability in voice data. HMMs are statistical models that represent sequences of observed events, such as speech and may be used for modeling temporal dynamics of voice data. CNNs are deep learning models that may capture spatial features in voice data. RNNs process sequential data by maintaining a memory of previous inputs and may be used for temporal dependencies in voice data. DNNs are multi-layered neural networks that may learn complex patterns in voice data. SVMs are supervised learning models that find an optimal hyperplane to separate different classes of voice data. Transformers are advanced neural network architectures that use self-attention mechanisms to process sequential data. Transformers may process long-range dependencies in voice data. Autoencoders are neural networks used for unsupervised learning and may be used for anomaly detection in voice data.

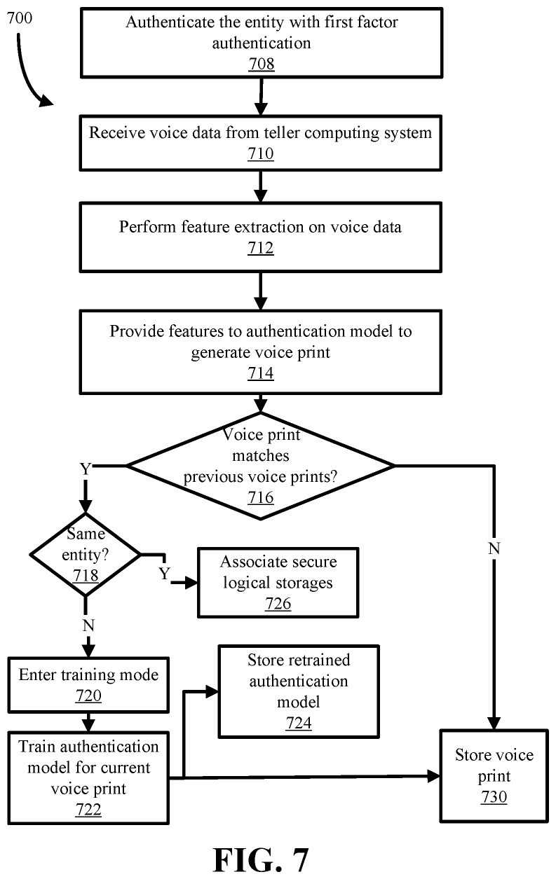

Turning to FIG. 7, the authentication model 612 may be trained for a new entity during an enrollment process 700. The enrollment process 700 may perform a first factor authentication of the entity at the teller-computing system 110 using their card at step 708. In the instance where the entity already has a card, the entity may provide their card to be read by the card reader module 270 and PIN entered by the keypad module 280. The card may be authenticated as previously described with reference to FIG. 2 above. In the instance where the entity does not have a card, the teller may provide the card to the card reader module 270. The teller-computing system 110 may set up the card with the resource server 130 by providing configuration data to the card. The entity may set up the PIN on the card, which may be communicated to the resource server 130 and stored in the respective secure logical storage. In some aspects, the entity may be required to provide identification, such as a driver's license or other form of photographic identification during the enrollment process 700. In some aspects, the identification may be captured by the image capture module 250 and/or may be provided to the resource server 130.

Once the first factor authentication is complete, the current entity may be asked to recite predetermined phrases and/or talk for a period until the authentication model 612 is able to discriminate between a voice of the current entity and other previous entities. The speech may be captured by the audio input module 240 and the voice data may be transferred from the teller-computing system 110 to the communications module 360 via the network 150 to be received by the resource server 130 at step 710. The processor 310 may route the voice data to one of the GPUs 504 executing the authentication model 612.

In some aspects, the voice data may be pre-processed at the teller-computing system 110 and/or at the processing structure 500. The pre-processing may involve removing background noise from the voice data. In some aspects, the processing structure 500 may comprise an audio processor to extract one or more features from the voice data, such as one or more Mel-frequency cepstral coefficients (MFCCs), pitch, formants, tone, speaking style, vocal timbre, pitch, speech patterns, physiological attributes, etc. The MFCCs may include a representation of short-term power spectrum of the voice data. The audio processor may include a discrete hardware processor associated with the computer server system 300 or, in other aspects, be a feature extraction process 712 executing on one of the GPUs 504. In some aspects, the feature extraction process 712 may execute on the GPU 504 that is the same as the GPU 504 executing the authentication model 612.

The extracted features may be provided to the authentication model 612 at step 714. The authentication model 612 may have been previously trained on voice data from other entities. In other aspects, the authentication model 612 may have been previously trained on synthetic voice data, such as generated by a text-to-speech engine and/or a large repository of speech data. One step may be to provide the extracted features and/or the voice data from the current entity to the authentication model 612 to generate a current voiceprint. The current voiceprint may comprise embeddings and/or feature vectors. The current voiceprint may be compared to previous voiceprints at step 716. The previous voiceprints may have been generated in the same or similar manner as the current voiceprint.

When the current voiceprint does not match any of the previous voiceprints, the authentication model 612 may store the current voiceprint in a voiceprint database at step 730 and associate the current voiceprint with a secure-logical storage associated with the entity. The matching of the current voiceprint and the previous voiceprints may involve generating a similarity score between the current voiceprint and the previous voiceprints. A similarity score may be generated using one or more metrics, such as, for example, a cosine similarity, to compare the previous voiceprints to the new voiceprint. For example, cosine similarity may provide a numerical value between −1 and 1 where 1 indicates the voiceprint vectors are identical in direction, 0 means the voiceprint vectors are orthogonal (completely dissimilar), and −1 means the voiceprint vectors are diametrically opposed. In some aspects, the range of cosine similarity may be restricted to [0, 1] for voiceprints as the embeddings may be normalized to non-negative values. When the similarity score exceeds a threshold, the current voiceprint and the previous voiceprint are a match.

When the current voiceprint matches one or more of the previous voiceprints, the authentication model 612 may determine the secure-logical storage associated with the previous voiceprint. The authentication model 612 may retrieve identification data for the current entity and identification data for the previous entity from their respective secure-logical storages. The identification data for both entities may be compared to determine if the current entity and the previous entity are, in fact, the same entity at step 718. When the current entity and the previous entity are the same entity, then the authentication model 612 may instruct the processor 310 to associate the secure-logical storages with each other at step 726.

When the current entity and the previous entity are different entities, the authentication model 612 may enter a training mode at step 720. In some aspects, the authentication model 612 may freeze one or more initial layers of the pretrained model to retain previously learned features. The freezing of the layers prevents weights of these layers from being updated during the training mode. One or more new layers may be added to the authentication model 612 to adapt the authentication model 612 to the current voiceprint. The new layers may be trained using the extracted features of the current voice data using backpropagation and/or optimization algorithms (e.g. gradient descent) at step 722. In some aspects, the matching previous voiceprints may be used to verify that the current voiceprint is distinct from the previous voiceprints in the retrained authentication model 612 (e.g. that the voiceprint comparison is below the threshold). Once retrained, the authentication model 612 may be stored in the model repository 630 for subsequent voice authentication of entities at step 724. The current voiceprint may be stored in the voiceprint database at step 730. In some aspects, the current voiceprint may be encrypted and stored on the computer-readable memory of the card.

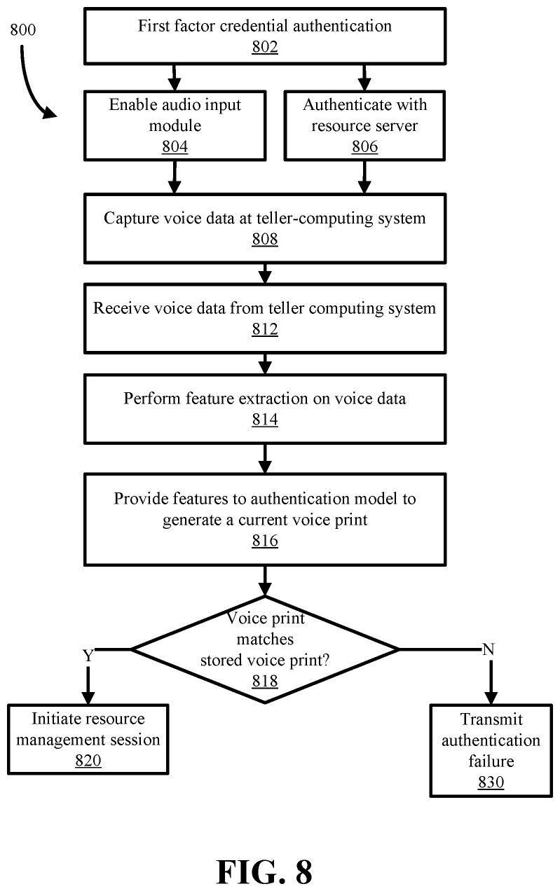

Turning to FIG. 8, an authentication process 800 for authenticating the entity at the teller-computing system 110 with the authentication server executing on the resource server 130 is shown. The authentication process 800 may include a first factor credential authentication at step 802. The first factor authentication may involve the entity providing their card to the card reader module 270 of the teller-computing system 110 to be read by the card reader module 270. The entity may enter their PIN into the keypad module 280. The first factor authentication may involve transmitting the PIN to the resource server 130 as previously described with regard to online PIN verification. The teller-computing system 110 may receive an authentication signal indicating first factor authentication confirmation and may enable audio capture in response thereto and this may be done in real-time. In some aspects, by enabling the audio capture at the teller-computing system 110 in response to receiving confirmation of the first factor authentication, delays and/or increased network load resulting from communication to and from the resource server 130 may be reduced and/or eliminated.

In some aspects, the first factor credential authentication may be performed locally to the teller-computing system 110, such as using chip and offline PIN authentication as previously described. In this manner, the local credential authentication may limit a delay in enabling the audio input module 240 of the teller-computing system 110 at step 804 thereby reducing the time to perform the voice authentication steps of the authentication process 800. In some aspects, by enabling the audio capture at the teller-computing system 110 in response to the first factor authentication, delays and/or increased network load resulting from communication to and from the resource server 130 may be reduced and/or eliminated.

At step 804, enabling the audio input module 240 may include adjusting one or more parameters of the audio input module 240. For example, a microphone calibration process may be performed by the teller-computing system 110 that may improve a signal-to-noise ratio of the entity's voice. The microphone calibration process may include adjusting a gain of one or more microphones. The microphone calibration process may include enabling or disabling one or more filters, such as a pop filter, a noise gate, an equalization. In some aspects, a plurality of microphones may be used to determine a position of the entity. Based on the position of the entity, the microphone calibration process may isolate the entity's voice from background noise. In some aspects, the position of the entity and the position of the teller may be determined to facilitate identifying entity voice data from teller voice data. In some aspects, the microphone calibration process may include adaptive beamforming to dynamically adjust a directionality of two or more microphones to better capture the entity's voice.

The first factor credential authentication may be performed in conjunction with the resource server 130 at step 806. In this aspect, the authentication with the resource server may be performed in parallel with enabling the audio input module 240 at step 804. Responsive to receiving the PIN, the teller-computing system 110 may encrypt the entered PIN using a secure encryption protocol before transmitting the PIN along with the card data over the network 150 via the communications module 260 to the resource server 130. The resource server 130 may validate the PIN against PIN data stored in a database. If the PIN is confirmed to match the card's associated account, the resource server 130 may send at least one signal over the network 150 notifying the teller-computing system 110 that the authentication was successful. Once the authentication with the resource server 130 is complete, the resource server 130 may identify the secure-logical storage associated with the card and may relay this data to the teller-computing system 110.

Although the aspects herein describe the first factor credential authentication using a card, other aspects may have the first factor credential authentication using a username/password and/or biometrics (e.g. facial recognition, fingerprint scan, etc.). Although the aspects recite a first factor credential authentication, in some aspects, the resource server 130 may perform a two-factor authentication (2FA), such as sending a code (e.g. a one-time password (OTP)) via email and/or short message service (SMS), and/or generated by an authenticator application to be provided to the resource server 130.

Following the enablement of the audio input module 240, the resource management application 412 executing on the teller-computing system 110 may prompt the entity to conduct a voice authentication. The prompt may be an audio prompt, a textual prompt, and/or an image prompt. In some aspects, the resource management application 412 may provide one or more authentication phrases that the entity is to recite. In some aspects, the content generator 620 may generate the authentication phrases. In some aspects, the content generator 620 may provide one or more images for display on the teller-computing system 110 that the entity is to verbally identify. The resource management application 412 may provide a countdown timer in which the entity may recite the authentication phrases. In other aspects, the resource management application 412 may provide a selectable interface element that the teller may press when recitation of the authentication phrases is complete.

The speech may be captured by the audio input module 240 at step 808 and the voice data may be transferred from the teller-computing system 110 to the communications module 360 via the network 150 where the resource server 130 receives the voice data at step 812. The processor 310 may route the voice data to one of the GPUs 504 executing the authentication model 612 in an authentication mode. In some aspects, the authentication model 612 may be trained to identify features of an automated voiceprint (e.g. a deepfake of the voiceprint) that may be impersonating the voiceprint. When the automated voiceprint is identified by the authentication model 612, the authentication model 612 may lock the secure-logical storage associated with the credentials.

As previously mentioned with reference to FIG. 7, the voice data may be pre-processed at the teller-computing system 110 and/or at the processing structure 500 to extract one or more features from the voice data at step 814. The extracted features may be provided to the authentication model 612 at step 816 to generate a current voiceprint. The voiceprint may comprise embeddings and/or feature vectors. The authentication process 800 may retrieve a stored voiceprint associated with the secure-logical storage from the authentication database. In some aspects, the stored voiceprint may be retrieved from the computer-readable memory within the card.

The current voiceprint may be compared to the stored voiceprint at step 818. When the current voiceprint does not match any of the stored voiceprints, the authentication model 612 may transmit an authentication failure message to the resource management application 412 and/or terminate a resource management session at step 830. The matching of the current voiceprint and the stored voiceprint may involve generating the similarity score between the current voiceprint and the stored voiceprints. In response to the similarity score exceeding the threshold, the current voiceprint and the stored voiceprint are a match and authentication is confirmed.

In response to the authentication failure message, the resource management application 412 may display a notification on the teller-computing system 110 that authentication has failed. In some aspects, the authentication failure message may initiate an alternative authentication method, such as a 2FA as previously described. If the 2FA fails, the resource management application 412 may deauthorize the resource management application 412 from accessing the secure-logical storage. If the 2FA succeeds, the resource management application 412 may maintain the resource management session.

In response to successfully authenticating the current voiceprint, the resource server 130 may create a resource management session and send a session token to the resource management application 412 at step 820. The resource management application 412 may retrieve data from the secure-logical storage associated with the credentials and display a dashboard or other home screen on the teller-computing system 110. In some aspects, the teller-computing system 110 may perform one or more resource management tasks associated with the secure-logical storage. The tasks may include depositing funds, withdrawing funds, determining an account balance, etc. In one or more aspects, the teller-computing system 110 may perform operations to deposit funds and this may be done in response to the teller-computing system 110 receiving one or more cheques. To deposit funds based on one or more cheques, the teller-computing system 110 may perform operations for real-time cheque processing.

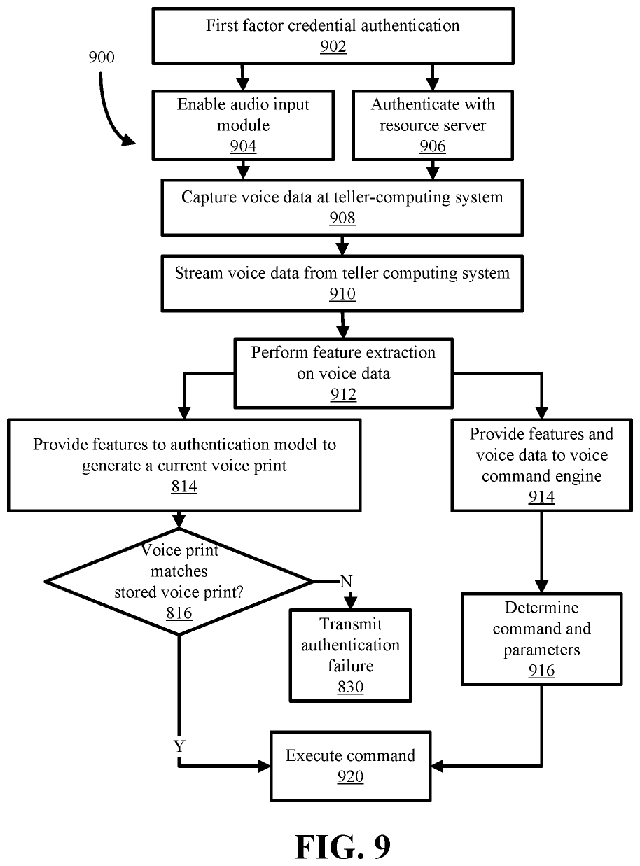

Rather than a distinct voice authentication process as shown in FIG. 8, FIG. 9 shows a continual identification process 900 that performs voice authentication during a substantial portion or the entirety of the session between the entity and the teller. The continual identification process 900 may include a first factor credential authentication 902. The first factor credential authentication 902 may involve the entity providing their card to the card reader module 270 of the teller-computing system 110 to be read by the card reader module 270. The entity may enter their PIN into the keypad module 280. The PIN may be verified by the resource server 130 as previously described.

In some aspects, the first factor credential authentication 902 may be performed locally to the teller-computing system 110, such as using chip and offline PIN authentication. The local credential authentication may limit a delay in enabling the audio input module 240 of the teller-computing system 110.

The first factor credential authentication 902 may enable the audio input module 240 at step 904. As the voice authentication is not performed until the first factor credential authentication 902 is complete, the capture and/or processing of irrelevant audio data may be prevented or reduced. The first factor credential authentication 902 ensures that an entity is present at the teller-computing system 110. at step 904.

At step 904, enabling the audio input module 240 may include adjusting one or more parameters of the audio input module 240. For example, a microphone calibration process may be performed by the teller-computing system 110 that may improve a signal-to-noise ratio of the entity's voice. The microphone calibration process may include adjusting a gain of one or more microphones. The microphone calibration process may include enabling or disabling one or more filters, such as a pop filter, a noise gate, an equalization. In some aspects, a plurality of microphones may be used to determine a position of the entity. Based on the position of the entity, the microphone calibration process may isolate the entity's voice from background noise. In some aspects, the position of the entity and the position of the teller may be determined to facilitate identifying entity voice data from teller voice data. In some aspects, the microphone calibration process may include adaptive beamforming to dynamically adjust a directionality of two or more microphones to better capture the entity's voice.

The first factor credential authentication 902 may be performed in conjunction with the resource server 130 at step 906. In this aspect, the authentication with the resource server may be performed in parallel with enabling the audio input module 240 at step 904. Responsive to receiving the PIN, the teller-computing system 110 may encrypt the entered PIN using a secure encryption protocol before transmitting the PIN along with the card data over the network 150 via the communications module 260 to the resource server 130. The resource server 130 may validate the PIN against PIN data stored in a database. If the PIN is confirmed to match the card's associated account, the resource server 130 may send at least one signal over the network 150 notifying the teller-computing system 110 that the authentication was successful. Once the authentication with the resource server 130 is complete, the resource server 130 may identify the secure-logical storage associated with the card and may relay this data to the teller-computing system 110.

In response to being activated, the remote-computing device may capture voice data from the audio input module 240 at step 908. The voice data may be streamed as a continuous voice data stream of voice data to the resource server 130 via the network 150. The continuous voice data stream may be captured immediately following the first factor authentication, such as offline PIN verification and/or online PIN verification, and may continue until a removal of the card from the card reader module 270. In some aspects, the voice data stream may continue until the voice command engine 614 determines that the teller-entity session has ceased. For example, the voice command engine 614 may determine one or more closing statements within the voice data stream, such as “thank you”, “that's all for today”, “have a good day”, “goodbye”, etc. In some aspects, the tellers may be trained to speak specific phrases to prompt closure of the teller-entity session.

The resource server 130 may receive the continuous voice data stream at step 910. As previously mentioned with reference to FIG. 7, the voice data stream may be pre-processed at the teller-computing system 110 and/or at the processing structure 500 to extract one or more features from the voice data stream at step 912. In some aspects, the voice data stream may be separated into voice data associated with the teller (e.g. teller voice data) and voice data associated with the entity (e.g. entity voice data). The separation of the voice data may be performed by the processing structure 500 and may be based at least on a voiceprint for the entity and a voiceprint for the teller. In some aspects, the separation may assume that any voice data that does not match the voiceprint for the entity is the teller voice data. In some aspects, the teller voice data may be identified based on a context identified within the voice data. For example, when the voice command engine 614 identifies a phrase, such as “Hello, welcome to the <establishment name>”, the voice command engine 614 may determine that voice data as the teller voice data. The entity voice data may be pre-processed to extract one or more features from the entity voice data.

As previously described previously, the extracted features from the entity voice data may be provided to the authentication model 612 at step 814 to generate a current voiceprint. The voiceprint may comprise embeddings and/or feature vectors. The stored voiceprint associated with the secure-logical storage may be retrieved from the authentication database. In some aspects, the stored voiceprint may be retrieved from the computer-readable memory of the card.

The current voiceprint may be compared to the stored voiceprint at step 816. The matching of the current voiceprint and the stored voiceprint may involve generating the similarity score between the current voiceprint and the stored voiceprints. In response to the similarity score exceeding the threshold, the current voiceprint and the stored voiceprint are a match and authentication is confirmed. Since the voice data is being streamed throughout the session between the teller and entity, the similarity score may be continually computed by the authentication model 612 forming a similarity score signal. In this manner, the similarity score signal may be an amplitude varying time-based signal. In some aspects, the similarity score signal may be integrated or averaged to prevent spurious authentication failures where the similarity score may fall below the threshold.

When the current voiceprint does not match the stored voiceprint for a predetermined period, the authentication model 612 may transmit an authentication failure message to the resource management application 412 at step 830. In some aspects, when the current voiceprint does not match the stored voiceprint, a halt message may be provided to the voice command engine 614 to stop the process of determining the command and/or parameters. In some aspects, when the current voiceprint does not match the stored voiceprint, the execute command at step 920 may be suppressed.

In some aspects, the authentication model 612 may be trained to identify features of an automated voiceprint (e.g. a deepfake of the voiceprint) that may be impersonating the voiceprint. When the automated voiceprint is identified by the authentication model 612, the authentication model 612 may lock the secure-logical storage associated with the credentials.

Simultaneous or nearly simultaneous to the generation of the voiceprint at step 814, the audio features and/or the voice data may be provided to a voice command engine 614 at step 914. In some aspects, the authentication model 612 may execute on a GPU 504 that is different than the GPU 504 executing the voice command engine 614. In other aspects, the authentication model 612 may execute on a GPU 504 that is the same as the GPU 504 executing the voice command engine 614.

The voice command engine 614 may include being previously trained on a plurality of commands to produce a plurality of command embeddings. The plurality of command embeddings may be stored in a command embeddings database. The voice command engine 614 may include being previously trained on a plurality of parameters to produce a plurality of parameter embeddings. The plurality of parameter embeddings may be stored in a parameter embeddings database. In some aspects, the plurality of command embeddings may be generated by a large language model. Likewise, the plurality of parameters may be generated by a large language model. In some aspects, the voice data may be transformed into textual data with a speech-to-text engine prior to being provided to the large language models. In some aspects, the voice command engine 614 may comprise a large language model to determine a command and/or at least one parameter associated with the command based on the textual data. In another aspect, the voice command engine 614 may receive the voice data and may determine the command and/or the at least one parameter within the voice data.

At step 916, the voice command engine 614 may process the voice data into at least one embedding. The at least one embedding may be compared to the plurality of command embeddings and/or the plurality of parameter embeddings. The comparison may generate a score between the at least one embedding and the plurality of command embeddings and/or the plurality of parameter embeddings. Based on the score, the voice command engine 614 may determine one or more of the commands from the plurality of command embeddings and/or determine one or more parameters from the plurality of parameter embeddings. In some aspects, the voice command engine 614 may process both the entity voice data and the teller voice data. In other aspects, the voice command engine 614 may process the entity voice data and the teller voice data separately.

In response to the current voiceprint matching the previous voiceprint associated with the secure-logical storage, the resource server 130 may execute the command at step 920. The execution of the command may involve transmitting an activation message to the resource management application 412 executing on the teller-computing system 110 and/or executing a command process on the resource server 130 associated with the determined command. In response to the activation message, the resource management application 412 may enable one or more modules.

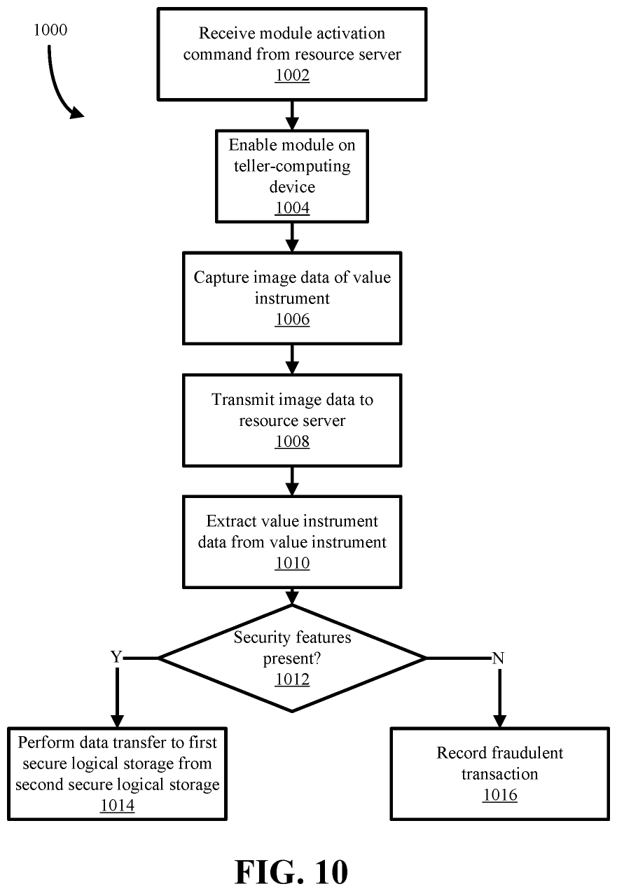

Turning to FIG. 10, there is provided an example of the execute command at step 920. As shown in the figure, a value instrument deposit process 1000 is performed. In this example, the entity may provide a spoken command to the teller, such as “I would like to deposit this cheque to my savings account”, captured within the voice data by the audio input module 240. The voice data may be streamed to the resource server 130 and processed by the continual identification process 900 as previously described. In response to the continual identification process 900, the determined command may be identified as “cheque deposit” and the parameter may be identified as “savings account”. The teller-computing system 110 may receive the deposit cheque command (e.g. an activation signal) from the resource server 130 at step 1002.

The activation signalling between the resource server 130 and the teller-computing system 110 may be performed in any suitable manner. For example, the resource server 130 may send a signal causing the teller-computing system 110 to enable a selectable interface element of the resource management application 412 for capturing image data. The resource management application 412 may wait for the teller to activate the selectable interface element whereby the resource management application 412 may capture the image data. The selectable interface element may be a button, icon, and/or other user interface element and may be labelled “Capture Image” or provide some other indication the selectable interface element is used to capture images, such as a camera icon. In some aspects, the selectable element may open a camera application on the teller-computing system 110.

In another example, the resource server 130 may perform the activation signalling using a full-duplex communication channel, such as WebSockets, between the teller-computing system 110 and the resource server 130. In this aspect, the resource server 130 may provide the activation signal via a push notification and in response to the push notification, the teller-computing system 110 may enable the selectable element for capturing the image data.

In yet another example, the teller-computing system 110 may poll the resource server 130 to retrieve the activation signal and in response to retrieving the activation signal, may enable the capture image module and/or enable the selectable element for capturing the image data.

In yet another example, the resource server 130 may transmit an SMS message to the teller-computing system 110 with a payload. The payload may include one or more instructions for the resource management application 412 to enable the selectable element and/or execute the camera application. In some aspects, when the image data is captured, the resource management application 412 may transmit the image data to the resource server 130 by way of a multimedia messaging server (MMS) message.

In another example, the resource server 130 may send an application programming interface request (i.e. an API request) to the teller-computing system 110. The API request may trigger a camera event in the resource management application 412 to launch the camera application.

The teller-computing system 110 may interpret the activation signal to determine the activation signal is the deposit cheque command. In response to the activation signal, the resource management application 412 may enable a module, such as the image capture module 250, at step 1004. The image capture module 250 may provide an image capture interface on the output interface module 220, such as a display, of the teller-computing system 110. In some aspects, the image capture interface may include a separate camera application executed in response to the activation signal. The image capture interface may provide image data from a camera associated with the teller-computing system 110. The image data may comprise at least a portion of the value instrument.

In some aspects, to facilitate image capture, the teller-computing system 110 may display an image representing a desired capture area together with a viewfinder representing the image data received from the camera. For example, the desired capture area may be displayed on a common page as the viewfinder to allow a user to attempt to use the desired capture area as a model when framing a photo of the value instrument. In some aspects, the image representing the desired capture area may be overlaid on the viewfinder. The overlay may facilitate image capture by allowing the entity to attempt to make live camera data align with the desired capture area. In the overlay, the desired capture area may be displayed as a semi-transparent overlay so as not to block the live camera data. In some aspects, the teller-computing system 110 may comprise a scanner where the cheque may be placed in a feeder and fed through a scanning system.

In enabling image capture, the teller-computing system 110 may enable a camera shutter button (e.g. a selectable interface element) to allow the camera shutter button to be selected to trigger image capture. That is, until the teller-computing system 110 determines that the image data corresponds to the value instrument, the camera shutter button may be disabled and, in response to this determination, the camera shutter button may be enabled. In some aspects, in enabling image capture, the teller-computing system 110 may automatically adjust camera settings. For example, the teller-computing system 110 may automatically zoom an image and/or may automatically focus.

In other aspects, enabling capture of the image data may include updating the graphical user interface to indicate that image capture is available. For example, when the image data corresponds to the value instrument, the GUI may be updated. By way of example, the output interface module 220 may frame around the viewfinder to indicate the image data corresponds to the value instrument, such as by turning green.

The image capture interface may remain on the output interface module 220 until the image data resembles a value instrument, thereby initiating an automatic capture of the value instrument at step 1006, or until a cancel button is executed by the entity. The value instrument may be determined to be in the image data using one or more image processing steps performed by the teller-computing system 110, such as using edge detection to identify one or more boundaries of the value instrument. The image processing steps may involve processing the boundaries using a contour detection process to find a four-sided polygon within the image data. In some aspects, the image data may be analyzed to obtain metadata associated with the value instrument. In one or more aspects, the teller-computing system 110 may engage an optical character recognition module to obtain the metadata. The optical character recognition module may analyze the image of the value instrument to obtain the metadata and the metadata may include, for example, drawee such as for example the transit number, institution number and account number of the account from which the funds are to be drawn. The metadata may include value instrument data that identifies the payee's name, the amount and currency of the transaction, a date, account number, etc. In some aspects, the metadata may be used to populate at least some of the data entry fields.

In some aspects, the image data may be transferred to the resource server 130 at step 1008. In this aspect, the resource server 130 may perform the one or more image processing steps, such as using edge detection to identify one or more boundaries of the value instrument. The image processing steps may involve processing the boundaries using a contour detection process to find a four-sided polygon within the image data. In some aspects, the value instrument data may be extracted, such as date, payee name, amount, a second secure-logical storage, a second resource server, etc. using an optical character recognition (OCR) process at step 1010. In some aspects, the extracted value instrument data may be displayed on the teller-computing system 110 for confirmation of accuracy. In another aspect, the image data may be provided to a value instrument engine that has been previously trained to identify the metadata and/or the value instrument data from the image data of the value instrument.

In some aspects, the value instrument engine may have been previously trained to identify one or more security features of the value instruments and/or photographic fraud. The image data may be evaluated to ensure authenticity. For example, photographic fraud could involve an altered photograph (e.g., a photo altered using photo-editing software, such as Photoshop™), a recycled value instrument (e.g., a value instrument that has already been processed), etc.

When the security features are present at step 1012, the resource server 130 may perform a data transfer to a first secure-logical storage associated with the entity from the second secure-logical storage at step 1014. Step 1014 may involve modifying the data of the first secure-logical storage associated with the entity and stored on the resource server 130. The resource server 130 may transfer the image data and/or the value instrument data to the central counterparty server 120. The central counterparty server 120 may identify the second resource server and the second secure-logical storage and route the image data and/or the value instrument data to the second resource server. The second resource server may modify the amount of data from the second secure-logical storage. In aspects where the resource server 130 and the second resource server are the same resource server, the resource server 130 may bypass transferring the image data and/or the value instrument data to the central counterparty server 120 and may directly modify the amount of data from the second secure-logical storage.

When the security features are not present at step 1012, the resource server 130 may record a potentially fraudulent transaction to have occurred at step 1016. The resource server 130 may provide a potential fraudulent transaction notification to the central counterparty server 120. In response, the central counterparty server 120 may identify similar transactions based on the image data and/or the value instrument data.

In at least some aspects described herein, the resource server 130 may enable image capture when the voice authentication passes to reduce a risk of fraud and/or to eliminate a transmission and processing of potentially fraudulent value instruments, which consumes network bandwidth and/or may require downstream mitigation of fraudulent value instruments being deposited and later detected as fraudulent. By performing voice authentication before enabling the image capture module 250, the techniques described herein ensure that only authorized users can access sensitive functionalities thereby reducing risk of unauthorized access or misuse. In this manner, the voice authentication may act as both a trigger and a security layer without requiring additional manual authentication steps or reducing the number of additional manual authentication steps improving security and efficiency.

The voice authentication may require less computational power than processing the image data. By delaying image capture until voice authentication is successful, the aspects herein avoid unnecessary processing of the image data that may be rejected due to unauthorized access attempts. The voice authentication may be performed efficiently using lightweight algorithms, and in some aspects, on the teller-computing system 110 rather than the resource server 130, thereby reducing the computational resources of the resource server 130 to process the voice authentication and/or image data. The efficient voice authentication may enable the resource server 130 to allocate computational resources on the image capture and processing only when the voice authentication one the command is successful. The aspects herein may prevent the resource server 130 from overloading during potentially fraudulent image capture attempts, such as by way of a denial-of-service attack.

By performing voice authentication, the aspects herein may avoid capturing and/or storing image data for unauthorized users, which would unnecessarily consume storage and/or processing power. The voice authentication prior to the image capture may ensure that the image data is only captured for authentic transactions thereby reducing computing resources. The performance of the voice authentication may reduce fraudulent image data from being passed on to the central counterparty server 120 thereby reducing network consumption and/or mitigating cascading fraudulent transactions across the clearinghouse process. By limiting the image capture process to authenticated commands, resources are reserved for legitimate cases, reducing overall load on both computational power and storage.

In one or more aspects, responsive to receiving the image data of the value instrument, the resource server 130 and/or the parallel computing structure 502 may perform operations to analyze the image data to ensure that the image data is of sufficient quality. The image data is of sufficient quality may include image data that is not blurry and/or sufficient image data to process the value instrument. In one or more aspects, the resource server 130 may analyze the image to generate metadata and may compare the metadata to that obtained by the teller-computing system 110 to ensure that the metadata matches. The resource server 130 may determine that the image data is acceptable and in response the resource server 130 may send a signal that includes an indication of acceptance of the image data to the teller-computing system 110.

Although a specific example is provided regarding FIG. 10, this specific example is merely an example and one of skill in the art on review of the present application would acknowledge other examples are possible fully within the teachings of the present application.

In yet another example, the enabled module may include enabling a biometric sensor, such as a fingerprint sensor. The resource management application 412 may require a biometric verification to unlock a user interface of the resource management application 412. In a similar example, the enablement of modules may include enabling a Personal Identification Number (PIN) interface whereby the entity may enter a PIN. In some aspects, the PIN may be compared to a stored PIN within a payment card.

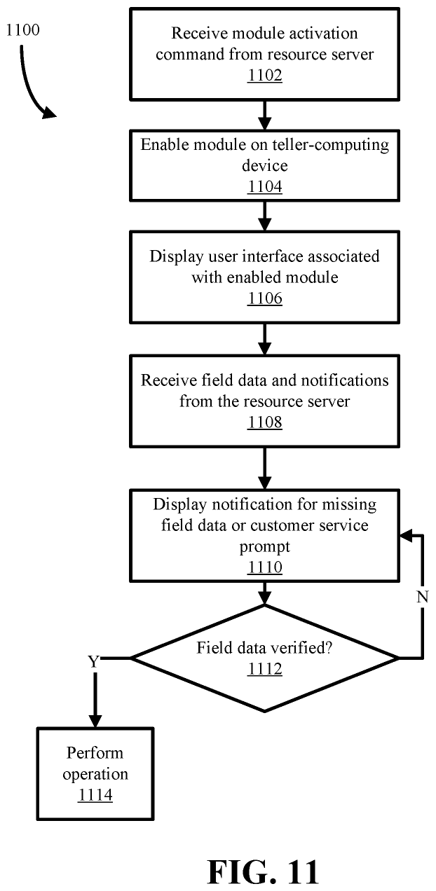

Turning to FIG. 11, there is provided another example of the execute command at step 920. As shown in the figure, a value transfer process 1100 is performed. In one example, the entity may provide a spoken command to the teller, such as “I would like to withdraw $1000 cash from my chequing account”, captured within the voice data by the audio input module 240. The voice data may be streamed to the resource server 130 and processed by the continual identification process 900 as previously described. In response to the continual identification process 900, the determined command may be identified as “cash withdrawal” and the parameters may be identified as “$1000 cash” and “chequing account”.

In another example, the entity may provide a spoken command to the teller, such as “I would like to transfer $1000 from my chequing account to my savings account”, captured within the voice data by the audio input module 240. The voice data may be streamed to the resource server 130 and processed by the continual identification process 900 as previously described. In response to the continual identification process 900, the determined command may be identified as “inter-account transfer” and the parameters may be identified as “$1000” and “from chequing account to savings account”.

The teller-computing system 110 may receive the command (e.g. an activation signal) from the resource server 130 at step 1102. The activation signalling between the resource server 130 and the teller-computing system 110 may be performed in any suitable manner. For example, the resource server 130 may send a signal causing the teller-computing system 110 to enable a software module to configure the resource management application 412 based on the identified spoken command. Although the term “software module” is used, the software module may activate one or more hardware devices, such as a cash drawer or cash dispenser.

In another example, the resource server 130 may perform the activation signalling using a full-duplex communication channel, such as WebSockets, between the teller-computing system 110 and the resource server 130. In this aspect, the resource server 130 may provide the activation signal via a push notification and in response to the push notification, the teller-computing system 110 may enable the software module.

In yet another example, the teller-computing system 110 may poll the resource server 130 to retrieve the activation signal and in response to retrieving the activation signal, may enable the software module.

In another example, the resource server 130 may send an application programming interface request (i.e. an API request) to the teller-computing system 110. The API request may trigger an event in the resource management application 412 to launch the software module.

The teller-computing system 110 may interpret the activation signal to determine the software module for execution. In response to the activation signal, the resource management application 412 may enable the selected software module, such as a cash withdrawal module or a transfer module, at step 1104.

In response to enabling the software module, the teller-computing system 110 may display a user interface associated with the enabled module at step 1106. For the example of a cash withdrawal, the enabled cash withdrawal module may display a cash withdrawal interface on the output interface module 220 of the teller-computing system 110. For the example of an inter-account transfer, the enabled inter-account transfer module may display a transfer interface on the output interface module 220 of the teller-computing system 110. These displayed interfaces may comprise one data input field or more data input fields and a selectable interface element.

At step 1108, the teller-computing system 110 may receive field data and notifications from the resource server 130. In some aspects, the field data may include one or more of the parameters. For instance, in the cash withdrawal interface, the field data may include current balances for one or more of the secure logical storages of the entity, the cash amount to be withdrawn, and the secure logical storage from which to withdraw the cash amount. For the transfer interface, the field data may include current balances for one or more of the secure logical storages of the entity, the transfer amount, the source secure logical storage, and the destination secure logical storage. In response to receiving the field data, the teller-computing system 110, via the software module, may populate the one or more data input fields with the field data.

At step 1110, the teller-computing system 110 may display one or more of the notifications received from the resource server 130. In some aspects, the voice command engine 614 may identify one or more of the data input fields that are missing field data or when further clarification is required. For the transfer example, the entity may have two chequing accounts and a notification may be provided to prompt the teller to ask which of the two accounts is to be used for the transfer. The one or more notifications may indicate to the teller that the teller should ask the entity for the missing data. In some aspects, the voice command engine 614 may identify one or more customer service prompts. For the cash withdrawal example, the notification may provide a prompt to the teller to ask the entity what denominations the entity would like to receive (e.g. 5×$20 bills).

Once all the missing field data and/or notifications have been addressed, the teller-computing system 110 may display a summary of the actions to be performed on the output interface module 220 at step 1112. If missing field data and/or notifications exist, the process returns to step 1110. Otherwise, the teller and/or the entity may confirm that the field data is accurate via a keypress on the keypad module 280, other input interface module 230, and/or a selection of the selectable interface element may transmit a selection signal to the resource server 130 on completion of the enabled module.

At step 1114, the teller-computing system 110 may perform the operation. For the cash withdrawal example, the teller-computer system 110 may dispense the cash via an automated cash dispenser and/or open a cash drawer. In the transfer example, the teller-computing system 110 may transmit the transfer instructions to the resource server 130 to perform the transfer between the secure logical storages.

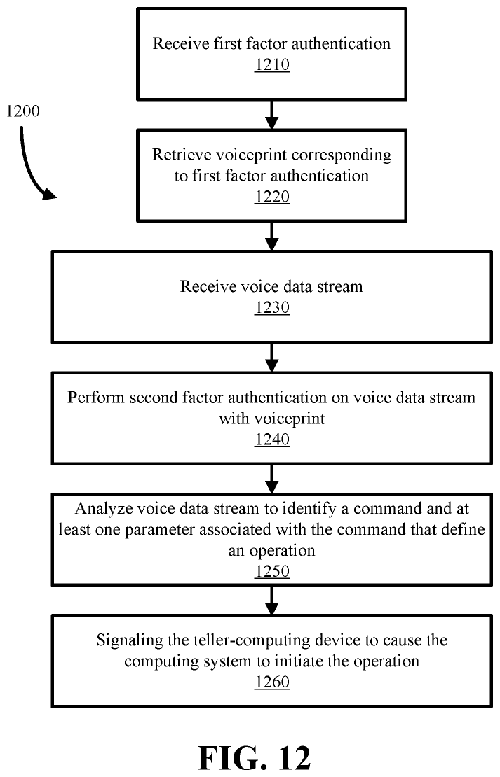

Turning to FIG. 12, a computer-implemented method 1200 is provided. The computer-implemented method may receive a first factor authentication (step 1210). The resource server 130 receives the first factor authentication and first factor authentication data in manners as described herein. For example, an entity may provide a card to the card reader module 270 of the teller-computing system 110 and enter a PIN on the keypad module 280. The confirmation of the successful first factor authentication may be determined offline or may be performed in conjunction with the resource server 130.

At step 1220, the resource server 130 may retrieve a voiceprint from a voiceprint database corresponding to the first factor authentication data. For example, the first factor authentication may comprise an account number that may be associated with or mapped to a particular voiceprint in the voiceprint database.

At step 1230, the resource server 130 may receive a signal from the teller-computing system that includes a voice data stream in manners as described herein. The voice data stream may be a continuous stream of voice data of the session between the teller and the entity.

At step 1240, the resource server 130 may perform a second factor authentication at least by performing voice authentication on at least a portion of the voice data stream with the voiceprint in manners similar to that described herein. An audio processor may extract one or more features from the voice data stream and provide those extracted features to an authentication model 612 to generate a current voiceprint. The voiceprint may be compared to the previously retrieved voiceprint to identify a match, such as by a similarity score exceeding a threshold.

At step 1250, the voice data may be analyzed to identify a command and at least one parameter associated with the command that define an operation in manners as described herein. For example, the voice data may be transformed into one or more embeddings and compared to command embeddings to identify the command. Similarly, the one or more embeddings and compared to parameter embeddings to identify the parameters. The resource server 130 may provide the voice data to the parallel computing server 140 to identify the command and the at least one parameter.

At step 1260, the resource server 130 may send an initiation signal causing the computing system to initiate the operation in manners as described herein. The parallel computing server 140 may provide structured data comprising the extracted command and the one or more extracted parameters to the resource server 130 to provide to the teller-computing system 110. For example, the LLM executing on the parallel computing server 140 may be trained with a plurality of commands that the teller-computing system 110 is configured to perform, such as column 2 of Table 1 below, along with instructional phrases to execute the commands. Once trained, the LLM may transform similar phrases from the entity into one or more of the commands. The commands may correspond to previously programmed functions and the one or more parameters may correspond to parameters that may be passed to the previously programmed functions.

The teller-computing system 110 may receive the structured data and may execute the respective function corresponding to the command from the data structure and may pass the parameters to the executed function. For example, the function may be “deposit(deposit_type, account_number)”. In some aspects, the function may determine which graphical user interface is to be loaded. The data entry fields of the graphical user interface may be automatically populated by one or more of the parameters passed to the function from the data structure received from the LLM. In this manner, the teller-computing system 110 may efficiently prepare the graphical user interface with prepopulated data for review by the teller for confirmation and/or requests for additional information from the entity. Further examples of commands and parameters are provided in Table 1 below. The table merely provides examples and is not exhaustive. In aspects, the structured data may provide instances where the teller, via the teller-computing system 110, may only confirm the operation instead of manual data entry thereby minimizing data entry errors in entering amounts, account details, etc.

TABLE 1

| | Structured Data | | |
|---|---|---|---|
| | Extracted | Extracted | Example Operation |
| Voice Data | Command | Parameter(s) | Taken |
| “I'd like to deposit this | deposit | cheque, account | Teller-computing system initiates image |
| cheque into my | | | capture interface to capture cheque. Teller- |
| account” | | | computing system retrieves account details |
| | | | from resource server. |
| “Withdraw $500 from | withdraw | 500, savings | Teller-computing system loads withdrawal |
| savings” | | | screen, pre-fills withdrawal form with $500 |
| | | | from savings, displays notification for entering |
| | | | desired bill values |
| “Transfer $200 to John | transfer | 200, John Doe | Teller-computing system loads transfer form, |
| Doe” | | | pre-fills transfer form to John Doe, and |
| | | | displays a notification requesting the source |
| | | | account. |
| “I'd like to cash this | cash | cheque | Teller-computing system initiates image |
| cheque.” | | | capture interface to capture cheque. |
| “I'd like to make a | payment | car loan | Teller-computing system loads payment form, |
| payment on my car | | | retrieves car loan data, pre-fills payment form, |
| loan” | | | and provides notification requesting amount to |
| | | | pay. |
| “Check my balances in | check_balance | all accounts | Teller-computing system displays account |
| my accounts” | | | balances for all (or requested) accounts |
| “I'd like to exchange | exchange | USD, CAD | Teller-computing system retrieves current |
| these US dollars for | | | exchange for USD to CAD, provides |
| Canadian dollars.” | | | notification requesting the amount, opens cash |
| | | | drawer. |
| “Can I get a bank draft | bank_draft | $1,000 | Teller-computing system loads bank draft |
| for $1,000?” | | | form, provides notification to source account |
| | | | and draft details. |
| “I need to update my | address_change | | Teller-computing system displays current |
| address on my | | | address and provides notification requesting |
| account.” | | | new address. |
| “My statement has an | statement_error | | Teller-computing system retrieves last |
| error.” | | | statement for review. |

The methods herein may be implemented by a computing device having suitable processor-executable instructions for causing the computing device to carry out the described operations. The methods may be implemented, in whole or in part, by the processor 200 of the teller-computing system 110. In one or more aspects, the processor 200 may offload some of the operations to the central counterparty server 120, the resource server 130, and/or the parallel computing structure 502.

The resource server 130 may determine that the image data is not acceptable or not of sufficient quality or may determine that transmission of the image data has not been successful. In response, the resource server 130 may send a signal that includes an indication of rejection of the image data to the teller-computing system 110.

In one or more aspects, the teller-computing system 110 may not receive a signal from the resource server 130. For example, the teller-computing system 110 may wait for a signal from the resource server 130 for a predefined amount of time such as for example five (5) seconds, ten (10) seconds, thirty seconds (30), etc. If no signal has been received from the resource server 130 within the predefined amount of time, the teller-computing system 110 may determine that sending the signal that includes the image data has timed out.

The above embodiments may be implemented in hardware, in a computer program executed by a processor, in firmware, or in a combination of the above. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

A storage medium may be coupled to the processor such that the processor may read information from, and write information to, the storage medium. In the alternative, the storage medium and the processor may share the same die. The processor and the storage medium may reside in an application specific integrated circuit (“ASIC”). In the alternative, the processor and the storage medium may reside as discrete components.

The aspects herein may execute on a cloud computing platform with on-demand availability of computer system resources, including data storage, and computing power, with automated active management. Clouds are often distributed, with data centers in multiple locations for availability and performance. Computing resources on clouds are shared across multiple tenants through virtual computing environments comprising virtual machines, databases, containers, and other resources. A container is an isolated, lightweight software for running an application on the host operating system. Containers are built on top of the host operating system's kernel and contain applications and some lightweight operating system APIs and services. Virtual machines are a software layer which include a complete operating system and kernel. Virtual machines are built on top of a hypervisor emulation layer designed to abstract a host computer's hardware from the operating software environment. Clouds generally offer hosted databases abstracting high-level database management activities.

Although an aspect of at least one of a system, method, and computer readable medium has been illustrated in the accompanying drawings and described in the foregoing detailed description, it will be understood that the application is not limited to the embodiments disclosed but is capable of numerous rearrangements, modifications, and substitutions as set forth and defined by the following claims. For example, the system's capabilities of the various figures can be performed by one or more of the modules or components described herein or in a distributed architecture and may include a transmitter, receiver, or pair of both. For example, all or part of the functionality performed by the individual modules may be performed by one or more of these modules. Further, the functionality described herein may be performed at various times and in relation to various events, internal or external to the modules or components. Also, the information sent between various modules can be sent between the modules via at least one of: a data network, the Internet, a voice network, an Internet Protocol network, a wireless device, a wired device and/or via a plurality of protocols. Also, the messages sent or received by any of the modules may be sent or received directly and/or via one or more of the other modules.

One skilled in the art will appreciate that the teller-computing system 110 may be embodied as a personal computer, a server, a console, a personal digital assistant (PDA), a cell phone, a tablet computing device, a smartphone, or any other suitable computing device, or combination of devices. Presenting the above-described functions as being performed by the teller-computing system 110 and/or resource server 130 are not intended to limit the scope of the present application in any way but is intended to provide one example of many embodiments. Indeed, methods, systems, and apparatuses disclosed herein may be implemented in localized and distributed forms consistent with computing technology.

Some of the system features described in this specification have been presented as modules to more particularly emphasize their implementation independence. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. The executables of an identified module may not be physically located together but may comprise disparate instructions stored in different locations which, when joined logically together, comprise the module and achieve the stated purpose for the module. Further, modules may be stored on a computer-readable medium, which may be, for instance, a hard disk drive, flash device, random access memory (RAM), tape, or any other such medium used to store data.

Indeed, a module of executable code may be a single instruction or many instructions and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations, including over different storage devices, and may exist, at least partially, merely as electronic signals on a system or network.

It will be readily understood that the components of the application, as generally described and illustrated in the figures herein, may be arranged and designed in a wide variety of different configurations. Thus, the detailed description of the embodiments is not intended to limit the scope of the application as claimed but is merely representative of selected embodiments of the application.

One having ordinary skill in the art will readily understand that the above may be practiced with steps in a different order and/or with hardware elements in configurations that are different from those which are disclosed. Therefore, although the application has been described based upon these aspects, it would be apparent to those of skill in the art that modifications, variations, and alternative constructions would be apparent.

While aspects of the present application have been described, it is to be understood that the aspects described are illustrative, and the scope of the application is to be defined solely by the appended claims when considered with a full range of equivalents and modifications (e.g., protocols, hardware devices, software platforms, etc.) thereto.

The various embodiments presented above are merely examples and do not limit the scope of this application. Variations of the innovations described herein will be apparent to persons of ordinary skill in the art, such variations being within the intended scope of the present application. Features from one or more of the above-described example embodiments may be selected to create alternative example embodiments including a sub-combination of features which may not be explicitly described above. In addition, features from one or more of the above-described example embodiments may be selected and combined to create alternative example embodiments including a combination of features which may not be explicitly described above. Features suitable for such combinations and sub-combinations would be readily apparent to persons skilled in the art upon review of the present application in its entirety. The subject matter described herein and in the recited claims intends to cover and embrace any changes in technology.

What is claimed is:

1. A server comprising:
a communications module;
at least one processor coupled to the communications module; and
a memory coupled to the at least one processor, the memory storing a plurality of processor-executable instructions which, when executed, configure the at least one processor to:
receive, via the communications module and from a computing system, a continuous voice data stream;
perform a second factor authentication at least by performing voice authentication of the continuous voice data stream with a voiceprint from a first factor authentication;
analyze the continuous voice data stream to identify a command and at least one parameter associated with the command that define at least one operation; and
send, via the communications module and to the computing system, an initiation signal that causes the computing system to initiate the at least one operation.

2. The server of claim 1, wherein when performing the voice authentication, the processor-executable instructions, when executed, further configure the at least one processor to:
generate a similarity score between the continuous voice data stream and the voiceprint; and
determine that the similarity score is above a threshold to complete the voice authentication.

3. The server of claim 1, wherein the processor-executable instructions, when executed, further configure the at least one processor to:
engage a large language model at least to analyze the continuous voice data stream to identify the command and the at least one parameter associated with the command.

4. The server of claim 3, wherein the large language model generates structured data that includes the command and the at least one parameter and the initiation signal includes the structured data that causes the computing system to initiate the at least one operation.

5. The server of claim 4, wherein the structured data is analyzed by the computing system to match the command to select the at least one operation.

6. The server of claim 5, wherein the computing system loads at least one graphical user interface associated with the at least one operation.

7. The server of claim 6, wherein the at least one graphical user interface includes at least one data input field and automatically populates the at least one data input field with at least a portion of the structured data.

8. The server of claim 7, wherein the graphical user interface includes at least one selectable interface element to complete the at least one operation; and the processor-executable instructions, when executed by the at least one processor, further configure the at least one processor to:
receive, via the communications module and from the computing system, a selection signal indicating a selection of the at least one selectable interface element to complete the at least one operation; and
perform the at least one operation.

9. The server of claim 1, wherein the processor-executable instructions, when executed by the at least one processor, further configure the at least one processor to:
identify at least one missing parameter for the command; and
send, via the communications module and to the computing system, a notification signal causing the computing system to display a notification that includes a request for the at least one missing parameter.

10. The server of claim 1, wherein the processor-executable instructions, when executed by the at least one processor, further configure the at least one processor to:
retrieve the voiceprint from a voiceprint database corresponding to a first factor authentication data.

11. The server of claim 10, wherein the first factor authentication data includes at least one of an account number and a token.

12. A computer-implemented method comprising:
receiving, via a communications module and from a computing system, a continuous voice data stream;
performing a second factor authentication at least by performing voice authentication on the continuous voice data stream with a voiceprint from a first factor authentication;
analyzing the continuous voice data stream to identify a command and at least one parameter associated with the command that define at least one operation; and
sending, via the communications module and to the computing system, an initiation signal causing the computing system to initiate the at least one operation.

13. The computer-implemented method of claim 12, wherein when performing the voice authentication, further comprising:
generating a similarity score between the continuous voice data stream and the voiceprint; and
determining that the similarity score is above a threshold to complete the voice authentication.

14. The computer-implemented method of claim 12, further comprising:
engaging a large language model at least to analyze the continuous voice data stream to identify the command and the at least one parameter associated with the command.

15. The computer-implemented method of claim 14, wherein the large language model generates structured data that includes the command and the at least one parameter and the initiation signal includes the structured data that causes the computing system to initiate the at least one operation.

16. The computer-implemented method of claim 15, further comprising:
analyzing, by the computing system, to match the command to select the at least one operation.

17. The computer-implemented method of claim 16, further comprising:
loading, by the computing system, at least one graphical user interface associated with the at least one operation; and
automatically populating at least one data input field with at least a portion of the structured data.

18. The computer-implemented method of claim 17, wherein the graphical user interface includes at least one selectable interface element for completing the at least one operation; and
receiving, via the communications module and from the computing system, a selection signal indicating a selection of the at least one selectable interface element for completing the at least one operation; and
performing the at least one operation.

19. The computer-implemented method of claim 12, further comprising:
retrieving the voiceprint from a voiceprint database corresponding to first factor authentication data.

20. A non-transitory computer readable storage medium comprising processor-executable instructions which, when executed, configure at least one processor to:
receive, via a communications module and from a computing system, a continuous voice data stream;
perform a second factor authentication at least by performing voice authentication on the continuous voice data stream with a voiceprint from a first factor authentication;
analyze the continuous voice data stream to identify a command and at least one parameter associated with the command that define at least one operation; and
send, via the communications module and to the computing system, an initiation signal causing the computing system to initiate the at least one operation.
